(19) United States
(12) Patent Application Publication
(10) Pub. No.: US 2005/0058165 A1
(43) Pub. Date: Mar. 17, 2005

(54) Laser having <100>-oriented crystal gain medium

(75) Inventors: James J. Morehead, Oakland, CA (US); Mark A. Arbore, Los Altos, CA (US); Gerald M. Mitchell, Los Altos, CA (US)

Correspondence Address: JOSHUA D. ISENBERG, 204 CASTRO LANE, FREMONT, CA, 94539, US

(73) Assignee: Lightwave Electronics Corporation, Mountain View, CA (US)

(21) Appl. No.: 10/661,435

(22) Filed: Sep. 12, 2003

(51) Int. Cl. H01S 3/14

(52) U.S. Cl. 372/39; 372/70

(57) ABSTRACT

The use of <100>-oriented crystals as gain media in lasers and optical amplifiers is disclosed. In a laser, a substantially <100>-oriented crystal, such as <100> YAG can be disposed within an optical cavity as a gain medium. The crystal is orientated such that a <100> plane is substantially perpendicular to a direction of beam propagation within the crystal. A pump source provides pumping energy to a pumped region of the crystal. The use of a substantially <100>-oriented crystal can reduce depolarization loss and thermal lens effects if an absorbed power of the pumping energy is less than or equal to about 1000 watts of pumping radiation and/or a cross-sectional overlap between a beam of radiation propagating through the crystal and the pumped region is greater than about 20% of a cross-sectional area of the pumped region.

### FIELD OF THE INVENTION

This invention generally relates to lasers and more specifically to the reduction of depolarization loss and thermal lensing in lasers having a crystal gain medium.

### BACKGROUND OF THE INVENTION

A common way to produce green (532 nm) and ultraviolet (355 nm and 266 nm) light is by sending the infrared (1064 nm) light produced by a Neodymium-doped Yttrium Aluminum Garnet (Nd:YAG) laser through nonlinear optical crystals. This frequency conversion depends on the polarization of the incoming beam. The part of the beam that is not polarized along a preferred polarization is lost. Thus it is important that the Nd:YAG laser rod not depolarize the signal beam passing through it. Even small losses inside a laser resonator can cause significant reductions in efficiency.

The YAG host material is naturally optically isotropic, i.e., there is no depolarization. However, in its use as a laser medium the YAG crystal is optically pumped. This heats up the crystal, with different parts expanding differently, leading to stresses. These stresses in the YAG crystal induce birefringence, and thus depolarization. It is of interest to minimize the amount of birefringence loss.

In the prior art, nearly all YAG lasers use crystals grown along the <111> direction and with beams propagating along the <111> direction. In 1970 Foster & Osterink and Koechner & Rice studied this thermally-induced birefringence in YAG rods grown along the standard crystal orientation <111> (see e.g., W. Koechner and D. Rice, “Effect of Birefringence on the Performance of Linearly Polarized YAG:Nd Lasers,” IEEE Journal of Quantum Electronics, vol. 6, pp 557-566, September 1970). The following year Koechner & Rice studied the dependence of the birefringence on the orientation of the crystal in the rods (see W. Koechner and D. Rice, “Birefringence of YAG:Nd Laser Rods as a Function of Growth Direction,” Journal of the Optical Society of America, vol. 61, no. 6, pp 758-766, June 1971). They found evidence that the rod axis along a crystal axis <100> (YAG is a cubic crystal) gives less depolarization than along <111>. However, Koechner and Rice did not report building a laser or optical amplifier. Furthermore, there was a fundamental mistake in their analysis, leading to a recommendation of the wrong input polarization, for which depolarization is worse than for <111>. This mistake was corrected in 2002 by Shoji & Taira, who (also without reporting ever building a laser or optical amplifier) concluded that at high power the <100> orientation produced half the depolarization of the <111> but that the <110>orientation produced 50 times less depolarization than the <111> (see I. Shoji and T. Taira, “Intrinsic Reduction Of The Depolarization Loss In Solid-State Lasers by use of a (110)-cut Y₃Al₅O₁₂ Crystal,” Applied Physics Letters, vol. 80, no. 17 29 Apr. 2002). Since that time, the laser industry has expressed an interest in using <110> YAG crystals as gain media but has shown no interest in <100> YAG as a gain medium.

Unfortunately, <110>-oriented YAG produces low depolarization only when the beam diameter is smaller than (e.g., about half) the diameter of the pumped region of the YAG crystal rod. However, the overall efficiency of the laser can be no better than the geometrical overlap between the beam and the pumped region. If, for example, the beam has 50% of the diameter of the pumped region, then the beam area overlaps with only 25% of the pumped region, indicating that 75% of the pump light is wasted. This tends to defeat the primary purpose of using <110> YAG, which is to reduce depolarization losses in order to improve the efficiency of the laser.

In high-power lasers, the induced thermal lens can be a limiting factor. The “direct” thermal lens comes from the dependence of the index of refraction on temperature. Furthermore, the thermally-induced stress changes the principal indices of refraction. Although Koechner has some discussion of these effective thermal lenses for <111>-oriented YAG, the inventors are not aware of anyone having discussed this for <100>-oriented crystal gain media. Both references in the prior art calculate the difference in principal indices of refraction (which is important for depolarization), but neither reports the indices separately (which is important for the effective thermal lens).

European Patent EP 1042847 and corresponding PCT publication WO 99/33486 describe the use of YAG <100> thin films deposited by liquid phase epitaxy as gain media and saturable absorbers in microlasers to provide stimulated radiation having a polarization that can be determined in advance of manufacture. According to these references, microlasers using epitaxial YAG <111> thin films have a polarization direction that depends generally on the residual stress engendered by the epitaxy. The direction of the polarization is not constant throughout all the surface of the substrate or strip within which the microlaser is cut. These references resolve the problem by depositing YAG <100> thin films as the gain medium and saturable absorber. However, these references do not address depolarization and thermal lens problems associated with thermally induced stress in YAG crystals used as a gain medium while the laser is operating. The thin layer gain medium described in these references is very thin and would probably be damaged (burned or cracked) long before absorbing sufficient power for thermal induced depolarization and thermal lens effects would become significant. Consequently, these references would not motivate one skilled in the art to use a <100>-oriented crystal to reduce these effects.

Thus, there is a need in the art, for a laser that overcomes the above disadvantages.

### SUMMARY OF THE INVENTION

Embodiments of the present invention are directed to the use in lasers and optical amplifiers of a crystal gain medium having a substantially <100> crystal orientation.

According to one embodiment, a laser includes an optically resonant cavity defined by two or more reflecting surfaces and a crystal disposed within the cavity. The crystal may be a garnet, such as yttrium aluminum garnet (YAG) or gadolinium scandium gallium garnet (GSGG). The crystal is characterized by an orientation such that a <100> plane of the crystal is oriented substantially perpendicular to a direction of beam propagation. A pump source can provide pumping energy to a pumped region of the crystal. An absorbed pump power of the pumping radiation is less than about 1000 watts and/or a cross-sectional overlap between a beam of radiation propagating through the crystal and the pumped region is greater than about 20% of a cross-sectional area of the pumped region. The use of the substantially <100>-oriented crystal reduces depolarization loss and thermal lensing compared to a substantially similarly configured gain medium made from the same material as the substantially <100>-oriented crystal but having instead a substantially non-<100>-orientation.

In an alternative embodiment, a substantially <100>-oriented crystal gain medium may be used without the optically resonant cavity, e.g., in an optical amplifier.

### BRIEF DESCRIPTION OF THE DRAWINGS

The teachings of the present invention can be readily understood by considering the following detailed description in conjunction with the accompanying drawings, in which:

FIG. 1 shows a graph of absorbed pump power for equal depolarization loss versus the ratio of beam diameter to pumping diameter for <110> YAG and <100> YAG.

FIGS. 2A-2D depict graphs of depolarization versus crystal orientation angle.

FIG. 3A depicts a schematic diagram of a laser according to an embodiment of the present invention.

FIG. 3B depicts a cross-section taken along line B-B of FIG. 3A

FIG. 4 depicts a schematic diagram of a frequency-tripled laser according to an embodiment of the present invention.

FIGS. 5A-5B depict schematic diagrams of alternative frequency tripled lasers according to embodiments of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. In the mathematical derivations described below certain assumptions have been made for the sake of clarity. These assumptions should not be construed as limitations on the invention. Accordingly, the exemplary embodiments of the invention described below are set forth without any loss of generality to, and without imposing limitations upon, the claimed invention.

Glossary:

As used herein:

The article “A”, or “An” refers to a quantity of one or more of the item following the article, except where expressly stated otherwise.

Cavity or Optically Resonant Cavity refers to an optical path defined by two or more reflecting surfaces along which light can reciprocate or circulate. Objects that intersect the optical path are said to be within the cavity.

Continuous wave (CW) laser: A laser that emits radiation continuously rather than in short bursts, as in a pulsed laser.

Diode Laser refers to a light-emitting diode designed to use stimulated emission to generate a coherent light output. Diode lasers are also known as laser diodes or semiconductor lasers.

Diode-Pumped Laser refers to a laser having a gain medium that is pumped by a diode laser.

Gain Medium refers to a lasable material as described below with respect to Laser.

Garnet refers to a particular class of oxide crystals, including e.g., yttrium aluminum garnet (YAG), gadolinium gallium garnet (GGG), gadolinium scandium gallium garnet (GSGG), yttrium scandium gallium garnet (YSGG) and similar.

Includes, including, e.g., “such as”, “for example”, etc., “and the like” may, can, could and other similar qualifiers used in conjunction with an item or list of items in a particular category means that the category contains the item or items listed but is not limited to those items.

Infrared Radiation refers to electromagnetic radiation characterized by a vacuum wavelength between about 700 nanometers (nm) and about 5000 nm.

Laser is an acronym of light amplification by stimulated emission of radiation. A laser is a cavity that is contains a lasable material. This is any material—crystal, glass, liquid, dye or gas—the atoms of which are capable of being excited to a metastable state by pumping e.g., by light or an electric discharge. The light emitted by an atom as it drops back to the ground state and emits light by stimulated emission. The light (referred to herein as stimulated radiation) oscillates within the cavity, with a fraction ejected from the cavity to form an output beam.

Light: As used herein, the term “light” generally refers to electromagnetic radiation in a range of frequencies running from infrared through the ultraviolet, roughly corresponding to a range of vacuum wavelengths from about 1 nanometer (10⁻⁹ meters) to about 100 microns.

Mode-Locked Laser refers to a laser that functions by controlling the relative phase (sometimes through modulation with respect to time) of each mode internally to give rise selectively to energy bursts of high peak power and short duration, e.g., in the picosecond (10⁻¹² second) domain.

Non-linear effect refers to a class of optical phenomena that can typically be viewed only with nearly monochromatic, directional beams of light, such as those produced by a laser. Harmonic generation (e.g., second-, third-, and fourth-harmonic generation), optical parametric oscillation, sum-frequency generation, difference-frequency generation, optical parametric amplification, and the stimulated Raman effect are examples.

Nonlinear Frequency Generation Processes are non-linear optical processes whereby input light of a given frequency f₀ passing through a non-linear medium interacts with the medium and/or other light passing through the medium in a way that produces output light having a different frequency than the input light. Harmonic Frequency Generation includes:
Higher Harmonic Generation (HHG), e.g., second harmonic generation (SHG), third harmonic generation (THG), fourth harmonic generation (FHG), etc., wherein two or more photons of input light interact in a way that produces an output light photon having a frequency Nf₀, where N is the number of photons that interact. For example, in SHG, N=2.
Sum Frequency Generation (SFG), wherein an input light photon of frequency f₁ interacts with another input light photon of frequency f₂ in a way that produces an output light photon having a frequency f₁+f₂.
Difference Frequency Generation (DFG), wherein an input light photon of frequency f₁ interacts with another input light photon of frequency f₂ in a way that produces an output light photon having a frequency f₁−f₂.

Non-linear material refers to materials that possess a non-zero nonlinear dielectric response to optical radiation that can give rise to non-linear effects. Examples of non-linear materials include crystals of lithium niobate (LiNbO₃), lithium triborate (LBO), beta-barium borate (BBO), Cesium Lithium Borate (CLBO), KDP and its isomorphs, LiIO₃ crystals, as well as quasi-phase-matched materials.

Phase-matching refers to the technique used in a multiwave nonlinear optical process to enhance the distance over which the coherent transfer of energy between the waves is possible. For example, a three-wave process is said to be phase-matched when k₁+k₂=k₃, where kᵢ is the wave vector of the i^{th} wave participating in the process. In frequency doubling, e.g., the process is most efficient when the fundamental and the second harmonic phase velocities are matched.

Q refers to the figure of merit of a resonator (cavity), defined as (2π)×(average energy stored in the resonator)/(energy dissipated per cycle). The higher the reflectivity of the surfaces of an optical resonator and the lower the absorption losses, the higher the Q and the less energy loss from the desired mode.

Q-switch refers to a device used to rapidly change the Q of an optical resonator.

Q-switched Laser refers to a laser that uses a Q-switch in the laser cavity to prevent lasing action until a high level of inversion (optical gain and energy storage) is achieved in the lasing medium. When the switch rapidly increases the Q of the cavity, e.g., with acousto-optic or electrooptic modulators or saturable absorbers, a giant pulse is generated.

Quasi-Phasematched (QPM) Material: In a quasi-phase-matched material, the fundamental and higher harmonic radiation are not phasematched, but a QPM grating compensates. In a QPM material, the fundamental and higher harmonic can have identical polarizations, often improving efficiency. Examples of quasi-phasematched materials include periodically-poled lithium tantalate, (PPLT), periodically-poled lithium niobate (PPLN) or PPKTP.

Vacuum Wavelength: The wavelength of electromagnetic radiation is generally a function of the medium in which the wave travels. The vacuum wavelength is the wavelength electromagnetic radiation of a given frequency would have if the radiation were propagating through a vacuum and is given by the speed of light in vacuum divided by the frequency.

Theorectical

Birefringence in a crystalline rod (or slab or other shape) of a gain medium such as YAG is related to the stress in the rod. Heating can cause stress in the rod. Birefringence and stress (or strain) can be described mathematically by matrices (rank-2 tensors). The linear relationship between them is then a rank-4 tensor (the elasto-optic tensor, p). For a given heating profile, at each point in a rod the stress can be found. The birefringence can then be found from the stress. The birefringence can be understood in terms of the principal polarizations, two special orthogonal polarizations for which there is no depolarization. The angle between one of the principal polarizations and the x-axis is referred to herein as θ. Then for the (assumed straight) ray with polarization at angle γ with respect to the x-axis, the amount of depolarization D in propagating a length L of gain medium is given by:

$$D = {sin}^{2} [ 2 ( θ - γ ) ] {sin}^{2} ( ψ / 2 ) , ψ = \frac{2 π}{λ} Δ n \cdot L ,$$

where Δn is the difference in indices of refraction between the two principal polarizations. In the depolarization, the first factor is a purely geometrical factor depending on the orientation of the principal polarization with respect to the signal's polarization, and the second is an evolution factor having to do with the amount of birefringence and the distance of propagation.

For any crystal orientation and any pumping profile the birefringence data θ and Δn can be computed. The simplest case, for which formulas can be derived, is a uniformly pumped rod. In that case, we can write:

$$ψ ( ϕ , r / {r}_{rod} ) = 2 Ω ( ϕ , r / {r}_{rod} ) \frac{{P}_{abs}}{{P}_{depol}} \frac{{r}^{2}}{{r}_{rod}^{2}} , \\ where {P}_{depol} = \frac{32 λ ( 1 - v ) κ}{α {η}_{h}} .$$

Here P_{abs} is the pump power absorbed by the rod, λ is the wavelength of signal (1.064 microns), ν is Poisson's ratio for YAG (0.25), κ is the thermal conductivity of YAG (0.014 W/mm°K), α is the thermal expansion of YAG (7.6×10⁻⁶/°K), and ηₕ is the fraction of absorbed pump power converted into heat, which we take as 0.3. The latter is a rough value for ηₕ. It can be measured and has been discussed, for example, in the paper by David C. Brown, “Heat, Fluorescence, and Stimulated-Emission Power Densities and Fractions in Nd:YAG”, IEEE JQE 34(3), pages 560-572 (March, 1998). Brown finds the ratio is generally between about 20% and 40%. Taking all these values into the equation above implies that P_{depol} is about 160 W.

The dimensionless factor Ω depends on the orientation of the crystal with respect to the cut of the rod, as does the angle θ to the principal polarization. At a position in the rod making angle φ to the x-axis, the principal axes for the three most common crystal orientations are
tan(2θ₁₁₁)=tan (2φ)

$$tan ( 2 {θ}_{100} ) = \frac{2 {p}_{44}}{{p}_{11} - {p}_{12}} tan ( 2 ϕ )$$

$$tan ( 2 {θ}_{110} ) = \frac{8 {p}_{44} sin ( 2 ϕ )}{\begin{matrix}[ 3 ( {p}_{11} - {p}_{12} ) + 2 {p}_{44} ] cos ( 2 ϕ ) - \\ ( {p}_{11} - {p}_{12} - 2 {p}_{44} ) ( 2 - {r}_{rod}^{2} / {r}^{2} )\end{matrix}}$$

where:
p₁₁=−0.029, p₁₂=0.0091, p₄₄=0.0615
are the elasto-optic coefficients of YAG. The birefringence strength functions are

$${Ω}_{111} = \frac{1}{3} {n}_{0}^{3} ( 1 + v ) ( {p}_{11} - {p}_{12} + 4 {p}_{44} )$$

Ω₁₀₀=n₀³(1+ν)\sqrt{(p₁₁−p₁₂)²cos²(2φ)+4p₄₄² sin²(2φ)}

$${Ω}_{110} = {n}_{0}^{3} ( 1 + v ) \sqrt{\begin{matrix}\frac{1}{16} ( ( 3 ( {p}_{11} - {p}_{12} ) + 2 {p}_{44} ) sin ( 2 ϕ ) - \\ {( {p}_{11} - {p}_{12} - 2 {p}_{44} ) ( 2 - {r}_{rod}^{2} / {r}^{2} ) )}^{2} + \\ 4 {p}_{44}^{2} {cos}^{2} ( 2 ϕ )\end{matrix}}$$

In the case of nonuniform pumping, the <111> and <100> results are still valid, provided φ is interpreted as the angle of the principal stress with respect to the x-axis. The <110> results need further modification involving their radial dependence.

Analysis

In the <111> orientation, the response is isotropic. The principal polarizations are along the principal stresses (radial and tangential for uniform pumping) and the size of the birefringence is uniform. For the <100> orientation, the directions of the principal polarizations are between the directions of the principal stresses and the diagonals between crystal axes (that is, the directions φ=45°, 135°, etc.), since κ=2p₄₄/(p₁₁−p₁₂)=3.23 is greater than 1. Thus if the input polarization is along a diagonal (γ=45°), the geometrical depolarization factor is smaller than for <111>. As for the strength of the depolarization, which enters into the evolution factor, it is minimal (40% of the <111> value) along the crystal axes and maximal (130% of <111>) along the diagonals. This favors the input polarization along the crystal axes. As discussed below, the geometrical effect dominates and the diagonals are the preferred polarizations. In addition, this realization means that Koechner and Rice's mistaken analysis predicts the wrong optimal polarization direction. The behavior of the <110> orientation is more complicated and is discussed below.

Of greater interest than the depolarization of one ray is the depolarization of a whole beam. Shoji & Taira consider top-hat shaped beams appropriate for high-power, highly multimode applications. For a Gaussian fundamental mode beam, the depolarization Dₚₒₗ is given by:

$${D}_{pol} = \frac{2}{π {r}_{beam}^{2}} {\int }_{0}^{∞} exp ( - 2 {r}^{2} / {r}_{beam}^{2} ) {sin}^{2} [ 2 ( θ - γ ) ] {sin}^{2} ( ψ / 2 ) \cdot r ⅆ r ⅆ ϕ ,$$

where r_{beam} is the 1/e²-power radius. The radial integral extends only to r_{rod}, of course, but if r_{beam} is enough smaller or if the absorbed power P_{abs} is much larger than P_{depol} (so that the evolution factor oscillates rapidly in radius), then the limit can be taken to infinity. In this case the integrals can be written down in closed form.

For the simplest case,

$${D}_{111} = \frac{{d}^{2}}{1 + 4 {d}^{2}} , d = {Ω}_{111} \frac{{P}_{abs}}{{P}_{depol}} {( \frac{{r}_{beam}}{{r}_{rod}} )}^{2} .$$

Notice that in the high-pumping limit, the depolarization is one quarter. The evolution factor oscillates rapidly in radius and averages to one half. The angular behavior always averages to one half in <111>, yielding the depolarization of one quarter. Thus the output beam in this limit is not totally depolarized, which would imply a depolarization of one half. For example, the beam is still perfectly polarized in the directions along the input polarization and perpendicular to it. (In the language of partial polarization, the Stokes parameters of the whole output beam are not zero, but one half in the direction of the input polarization.) In the low-pumping limit, the depolarization is simply d², which is quadratic in the absorbed pump power.

For the <100> orientation, the amount of depolarization depends on the input polarization. The minimum and maximum values, for polarization diagonal to and parallel to the crystal axes, respectively, are

$${D}_{100}^{min} = \frac{{B}^{2} / {k}^{2}}{2 \sqrt{1 + {B}^{2} / {k}^{2}} ( \sqrt{1 + {B}^{2}} + \sqrt{1 + {B}^{2} / {k}^{2}} )} , \\ {D}_{100}^{max} = \frac{{B}^{2}}{2 \sqrt{1 + {B}^{2}} ( \sqrt{1 + {B}^{2}} + \sqrt{1 + {B}^{2} / {k}^{2}} )} , where$$

$$B = 4 {p}_{44} {n}_{0}^{3} ( 1 + v ) \frac{{P}_{abs}}{{P}_{depol}} {( \frac{{r}_{beam}}{{r}_{rod}} )}^{2} , k = \frac{2 {p}_{44}}{{p}_{11} - {p}_{12}}$$

In the high-depolarization limit, these two approach

$${D}_{100}^{min} -> \frac{1}{2 ( k + 1 )} = 0.12 , {D}_{100}^{max} -> \frac{k}{2 ( k + 1 )} -> 0.38 ,$$

each of which can be compared with the <111> limit of 0.25. In the low-depolarization limit,

$$\frac{{D}_{100}^{min}}{{D}_{111}} -> {( \frac{3 ( {p}_{11} - {p}_{12} )}{{p}_{11} - {p}_{12} + 4 {p}_{44}} )}^{2} = 0.16 , \\ \frac{{D}_{100}^{max}}{{D}_{111}} -> {( \frac{6 {p}_{44}}{{p}_{11} - {p}_{12} + 4 {p}_{44}} )}^{2} = 1.69 .$$

Thus in both limits the <100> orientation with the polarization along the diagonal between the crystal axes has considerably less depolarization than the <111> orientation, about 6 times smaller in the low-depolarization limit and roughly 2 times smaller for large depolarization. So correctly oriented, the <100>-cut rods offer significantly less depolarization than the standard <111>-cut rods.

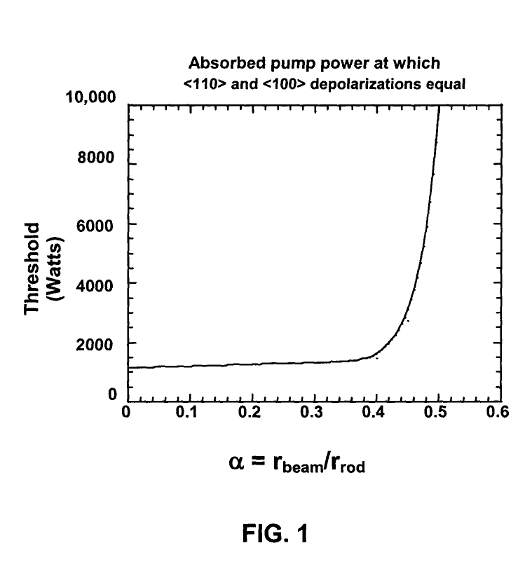

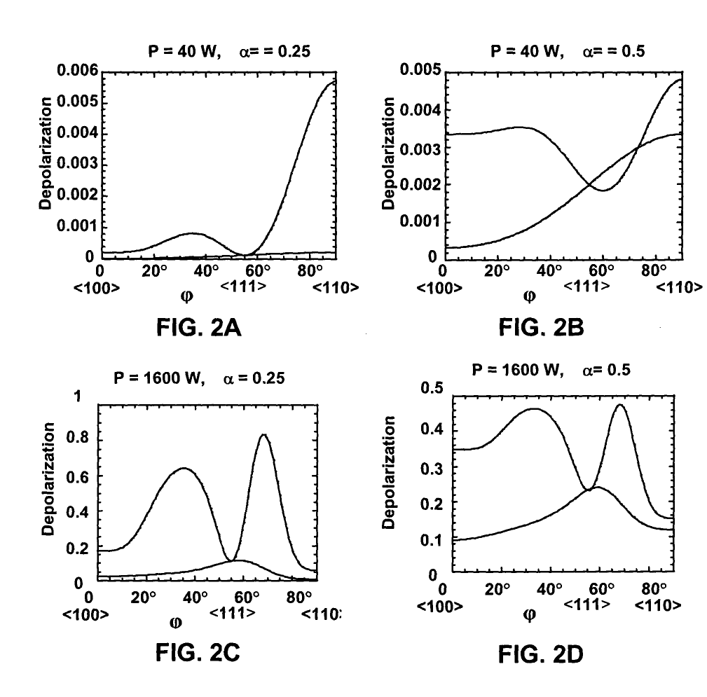

Some numerical results comparing <110> YAG and <100> YAG are summarized in FIG. 1 and FIGS. 2A-2D. FIG. 1 shows a graph of absorbed pump power for equal depolarization loss versus the ratio of beam diameter to diameter of a pumped region for <110> YAG and <100> YAG. For the sake of example, it is assumed that the beam and pumping cross-sections are circular and that the pumped region covers the entire cross-section of the rod, although this need not be the case. From FIG. 1 it can be seen that <110> has less depolarization than <100> when the beam diameter (defined, e.g., at 1/e² power) is less than about 45% of the diameter of the pumped region (so beam area less than about 20% cross-sectional area of the pumped region). Even then, the absorbed pump power must be greater than about 1000 Watts. So the <110> orientation has the advantage only for small, very high power beams. Thus, the inventor's calculations show that, for all other beams, <100> is the preferred orientation.

FIGS. 2A-2D show that there are no other orientations than <111>, <110>, and <100> that have even lower depolarization. For four cases (small beam or not-so-small beam, low power or high power), the depolarization for the best and worst input polarizations are graphed as a function of the rod's crystal growth direction φ. The rod's axis is taken from direction <100> (φ=0°) through direction <111> (φ=arcos(1/√3)=54.7°) to direction <110> (φ=90°). Notice that for orientation <111> the best and worst polarizations are equal. Also notice that the lowest amount of depolarization is always one of the endpoints, <100> or <110>. And in fact, only for relatively high-powers and relatively small modes is <110> best. Therefore, for less than about 1000 watts of absorbed pump power and/or greater than about 20% cross-sectional overlap between the beam and the pumped region a substantially <100> orientation is more desirable than a substantially non-<100> orientation. For the purposes of the present discussion, “substantially <100>” means sufficiently close to a <100> orientation that the depolarization loss is better, i.e., smaller, than a substantially non-<100> orientation, e.g., a <111> or <110> orientation.

For lasers of high power, depolarization is an important loss mechanism. Rods cut along the YAG crystal's <100> axis have much less loss at any pumping level and beam size than those cut along the standard <111> axis. For extremely high-power lasers (greater than about 1000 W absorbed pump power), rods cut along the <110> axis have lower depolarization than those along the <100>, but for unrealistically small beams. Thus, FIG. 1 and FIGS. 2A-2D show that for YAG lasers operating at an absorbed power below 1000 watts, <100> rods are the best choice.

Furthermore, these advantages can be applied to <100>-oriented gain media, such as GSGG, which have cubic crystal structure and have 3(p₁₁−p₁₂)<p₁₁−p₁₂+4p₄₄.

In addition, the <100> orientation also has better thermal lens properties than the <111> orientation. Analyzing uniform pumping for simplicity, the temperature profile is quadratic, leading to a quadratic index profile and a focusing lens. For the thermally induced birefringence analysis above only the difference in the indices mattered. For thermal lensing effects, the indices themselves matter. Under uniform pumping the principal polarizations are radial and tangential and the indices are quadratic in radius, like the thermal lens. The lens effects for the radial and tangential polarizations depend respectively on the radial and tangential refractive indices. Thus, there are two principal lenses, resulting in bifocusing.

For <111> YAG rods, the ratios of stress-induced lens strength to direct thermal lens strength are as follows. With the index's temperature derivative dn/dT=7.3×10⁻⁶/° C. and defining

$$C = \frac{{an}_{0}^{3}}{8 ( 1 - v ) \frac{ⅆ n}{ⅆ T}} = 1.05$$

the radial ratio is

$${ratio}_{radial}^{111} = \frac{C}{3} [ ( 7 - 17 v ) {p}_{11} + ( 17 - 31 v ) {p}_{12} - 8 ( 1 + v ) {p}_{44} ] = 0.217$$

and the tangential ratio is

$${ratio}_{tangential}^{111} = \frac{C}{3} [ ( 9 - 15 v ) {p}_{11} + ( 15 - 33 v ) {p}_{12} ] = 0.032$$

So for the radial polarization the stress lens adds about 22% to the thermal lens, whereas for the tangential polarization, the stress lens subtracts about 3% from the thermal lens. For <100> rods, the stress-lens strength depends on the orientation with respect to the crystal axes:
ratio_{radial}¹⁰⁰_{tangential}=C└(2−6ν)(p₁₁+p₁₂)±(1+ν)\sqrt{(p₁₁−p₁₂)² cos ²(2φ)+4p₄₄² sin²(2φ)}+4(1−ν)p₁₂┘,
where φ is the angle between the position and the crystal axis. The tangential-like lens varies from 18% of the direct lens (along diagonals) to 7% (along crystal axes), with an average of 13.2% of the direct lens. The radial-like polarization's stress lens varies from −14% (along diagonals) to −3.2% (along crystal axes), with an average of −9.5% Thus <100>-oriented rods have an 8% smaller effective thermal lens than <111>-oriented rods. This reduction allows <100> rods to be pumped at higher power than <111> rods for the same thermal lensing effect.

Since thermal lensing often limits the obtainable output power and/or stability range of any given laser design, it is advantageous to use a gain material with an intrinsically reduced thermal lens. All else being equal, with <100> YAG a laser designer can operate at higher absorbed pump powers and, therefore, higher gain and higher useful output power, which are typically beneficial. In general, for <100> YAG, the absorbed pump power can be increased (relative to <111> YAG) by the amount which results in the same thermal lens as would be observed in <111> YAG.

Thus, a laser or optical amplifier using a <100>-oriented crystal gain medium can have improved depolarization loss and thermal lens effects compared to a laser with a substantially similarly configured gain medium made from the same material as the <100>-oriented crystal but having instead a substantially non-<100>-orientation (e.g., <111> or <110>) if either or both of the following conditions are met:
(1) An absorbed pump power of the pumping radiation is less than about 1000 watts; or
(2) A cross-sectional overlap between the beam and the pumped region is greater than about 20% of a cross-sectional area of the pumped region.
   YAG <100> Lasers

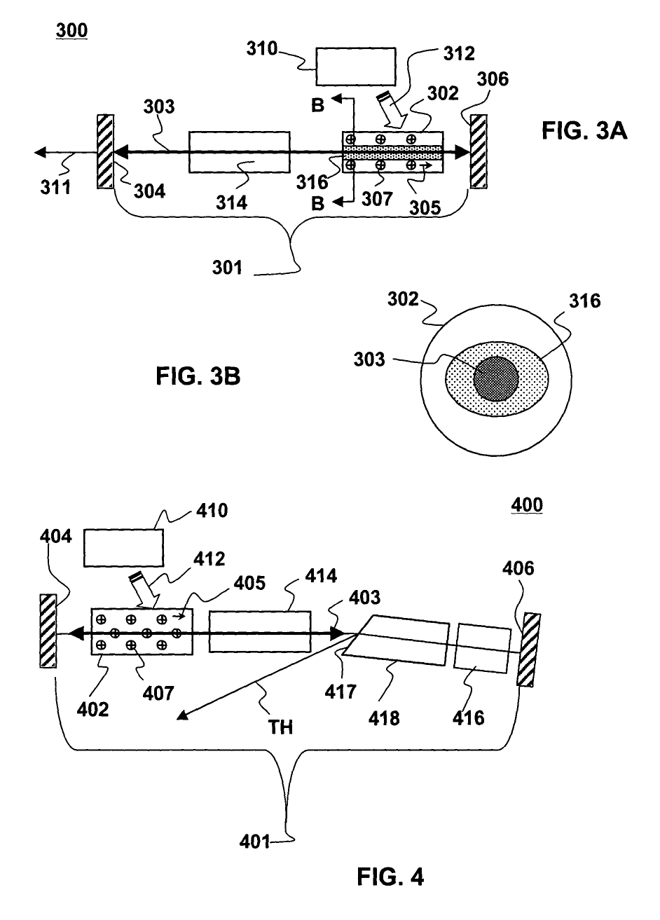

FIG. 3A depicts an example of a laser 300 according to an embodiment of the present invention. The laser 300 generally includes as a gain medium a <100>-oriented crystal 302 disposed within a cavity 301 defined, e.g., by two or more reflecting surfaces 304, 306. As described above, the use of a <100>-oriented crystals, such as <100> YAG in the laser 300 reduces problems associated with depolarization loss and thermal lensing.

The cavity 301 is configured to support a beam of stimulated radiation 303 from the crystal 302. By way of example, the beam of stimulated radiation 303 may be characterized by a frequency ω that corresponds to a vacuum wavelength, e.g., of about 1064 nm. Alternatively, the frequency ω can correspond to other vacuum wavelengths, e.g., about 946 nm or 1319 nm. The cavity 301 may be configured, e.g., by choosing the dimensions (e.g. radii), reflectivities and spacing of the reflectors 304, 306 such that the cavity 301 is a resonator capable of supporting radiation of fundamental frequency ω. One of the reflecting surfaces e.g., surface 304, may transmit a portion 311 of the radiation incident upon it from within the cavity 301. Although a linear cavity 301, having two reflecting surfaces is depicted in FIG. 3, those of skill in the art will be able to devise other cavities, e.g., having stable, unstable, 3-mirror, mirror, 4-mirror Z-shaped, 5-mirror W-shaped, cavities with more legs, ring-shaped, or bowtie configurations being but a few of many possible examples.

The crystal gain medium 302 may have any suitable shape, e.g., a rod, slab, and the like. The crystal gain medium 302 has its <100> crystal axis 305 orientated substantially parallel to a direction of propagation of a beam of the stimulated radiation 303. To reduce depolarization losses, the crystal gain medium 302 may be oriented such that the polarization of the stimulated radiation 303 is directed substantially along a diagonal between two other crystal axes. An unpolarized laser can also benefit from <100>, e.g., due to reduced thermal lens.

The crystal 302 may have two end surfaces through which the stimulated radiation 303 passes. The end surfaces of the crystal 302 may be normal (perpendicular) or near normal to the direction of propagation of the stimulated radiation 303 as shown in FIG. 3. Alternatively, the end surfaces may be situated at a Brewster's angle θ_{B} relative to the stimulated radiation 303, such that the stimulated radiation 303 is p-polarized with respect to the end surfaces, i.e. polarized in the plane of the plane of incidence of the stimulated radiation 303. Alternatively, end surfaces may be polished at some other angle.

It is often desirable that the crystal 302 not be naturally birefringent. Preferable non-birefringent crystalline materials for the crystal 302 include oxides such as garnets having a cubic crystal structure. Suitable garnets include yttrium aluminum garnet (YAG) and gadolinium scandium gallium garnet (GSGG).

In a preferred embodiment, the crystal 302 is a YAG crystal. The gain medium 302 may be doped with dopant ions 307, e.g. Nd³⁺ (so that a YAG crystal 302 is a Nd³⁺:YAG crystal). Alternatively, YAG can be doped with different ions, e.g., Tm:Ho:YAG, Yb:YAG, Er:YAG and Nd:YAG. Crystals of YAG <100>, with or without dopant ions are available commercially, e.g., from VLOC, Inc. of New Port Richey Fla.

The crystal 302 may be pumped (e.g., end-pumped or side-pumped) by a source 310 of pumping energy 312. An interaction between the pumping energy 312 and the crystal 302 produces the radiation 303. In view of the discussion above, depolarization loss and thermal lens effects in the <100>-oriented crystal 302 can be improved compared to a non-<100>oriented crystal if the crystal 302 absorbs the pumping energy 312 at a rate of less than about 1000 Watts. This can be accomplished, e.g., by appropriate configuration of the source 310 and/or the crystal 302. The pumping energy 312 may be in the form of radiation introduced through one or more sides and/or ends of the crystal 302. The pump source 310 may be a diode laser, in which case the laser 300 would be a diode-pumped laser. Alternatively, the laser 300 may be flashlamp-pumped. The pumping energy 312 can be in the form of radiation having a vacuum wavelength ranging from about 650 nm to about 1550 nm (for diode pumping) or visible or near ultraviolet (for flash lamp pumping). For Nd:YAG, e.g., the pumping radiation is typically at a vacuum wavelength of about 808 nm or about 880 nm.

A configuration in which the pumping energy is introduced through a side of the crystal 302 parallel to the beam of stimulated radiation 303 is referred to as side-pumping. Side-pumping may be enhanced, e.g., by disposing the crystal 302 within a pump cavity, i.e., an optical cavity configured to reflect the unabsorbed pumping energy 312 back into the crystal 302. The pump source 310, e.g., one or more diode lasers, may provide the pump energy 312 though a linear slit in the pump cavity oriented substantially parallel to the beam of radiation 303. Beam shaping elements, e.g., Brewster angle facets on the end of the crystal 302, may further enhance the coupling of the pump energy, e.g., by giving the beam of stimulated radiation 303 a generally elliptical shape within the crystal 302. Examples of such side-pumping schemes are described in commonly assigned U.S. Pat. Nos. 5,774,488 and 5,867,324, both of which are incorporated herein by reference.

The pumping energy 312 need not be distributed across the entire cross-sectional area of the crystal 302. As shown in FIG. 3B, the pumping energy 312 can be deposited in a pumped region 316 of the crystal 302 having a cross-sectional area that is less than a cross-section of the crystal 302. The beam of stimulated radiation 303 has a cross-section that overlaps at least a portion of the pumped region 316. As described above, depolarization loss and thermal lens effects in the <100>-oriented crystal 302 can be improved compared to a non-<100> oriented crystal, e.g., where the cross-sectional area of overlap between the beam of stimulated radiation 303 and the pumped region 316 is greater than about 20% of the cross-sectional area of the pumped region 316.

Although the pumped region 316 is depicted in FIG. 3B as having a substantially elliptical cross-section, other shapes can be used. For example, if a substantially circular beam overlaps a substantially circular pumped region, depolarization loss and thermal lens effects and bifocusing effects can be reduced in a <100>-oriented crystal compared to a non-<100>oriented crystal if the diameter of the beam is greater than about 45% of the diameter of the pumped region 316. Furthermore, although the beam of stimulated radiation 303 and the crystal 302 are shown in FIG. 3B as having substantially circular cross-sections or arbitrary cross-sectional shapes can also be used. In addition, for the purpose of example, FIG. 3B shows that all of the cross-section of the beam of stimulated radiation 303 overlaps at least a portion of the cross-section of the pump region 316. It is alternatively possible for more than 20% of the beam cross-section to overlap the pumped region even if part of cross-section of the beam 303 does not overlap the cross-section of the pumped region 316.

The laser 300 may operate in a continuous wave (CW) mode or a pulsed mode. To operate in a pulsed mode, the laser 300 may optionally include a pulsing mechanism 314 that facilitates generation of high-intensity radiation pulses (e.g. a Q-switch, a modelocker, passive saturable absorber, a gain control device or some combination thereof). In particular embodiments the pulsing mechanism is a Q-switch. The Q-switch may be an active Q-switch (e.g., using an electro-optic or acousto-optic modulator), or a passive Q-switch (e.g., using a saturable absorber).

Other variations on the laser of FIG. 3A include lasers that contain more than one section of gain material, more than one type of gain material, and the use non-linear materials. Non-linear materials may be used in conjunction with non-linear frequency generation, e.g., generation of higher or lower harmonics of the (fundamental) stimulated radiation produced by the crystal 302. Such non-linear materials may be phase matched to optimize frequency conversion processes involving the beam of stimulated radiation 303. Examples that are of particular interest include frequency tripled lasers.

FIG. 4 depicts a schematic diagram of an intracavity frequency-tripled laser 400 according to an embodiment of the present invention. The laser 400 includes a crystal gain medium 402 and optional pulsing mechanism 414 disposed within a cavity 401 defined by reflecting surfaces 404, 406. The crystal 402 may include dopant ions 407 that provide a metastable state. As described above, the crystal 402 has a garnet or equivalent crystal structure with a <100> axis 405 oriented along a direction of propagation of a beam of fundamental stimulated radiation 403. The cavity 401, crystal 402, reflecting surfaces 404, 406, and pulsing mechanism 414 may be as described above with respect to the corresponding components in laser 300 of FIG. 3. The laser 400 may further include a source 410 of pump radiation 412, which may be as described above.

The pump radiation 412 stimulates emission by the crystal 402 of a beam of stimulated radiation 403 of fundamental frequency ω, corresponding e.g., to a wavelength of about 1064 nm. The laser 400 further includes first and second non-linear elements 416, 418, e.g., non-linear crystals such as LBO, disposed within the cavity 401. The first non-linear element 416 is phase-matched for second harmonic generation, which produces radiation of frequency 2ω, corresponding, e.g., to a wavelength of about 532 nm. The second non-linear element 418 is phase-matched for sum frequency generation between the fundamental stimulated radiation 403 and the second harmonic radiation to produce third harmonic radiation TH of frequency 3ω, corresponding, e.g., to a wavelength of about 355 nm. The second non-linear element 418 may include a Brewster-cut face 417. Third harmonic radiation TH emerging from the second non-linear element through the Brewster-cut face 417 refracts out of the cavity 401 as output radiation from the laser. Fundamental stimulated radiation 403 remains within the cavity 401.

Frequency-tripled lasers of the type shown in FIG. 4 are described in detail, e.g., in commonly-assigned U.S. Pat. No. 5,850,407, which is incorporated herein by reference.

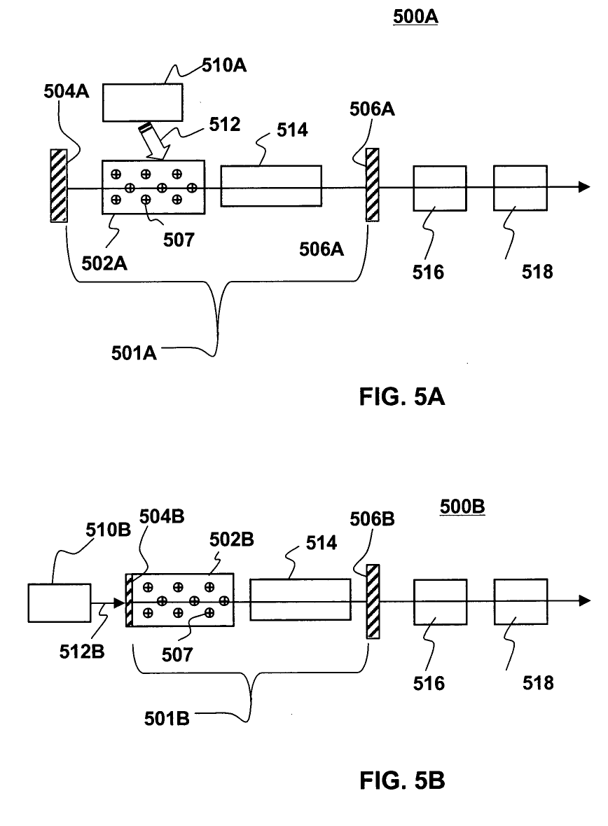

In the laser of FIG. 4, the frequency conversion occurs within the laser. Alternatively, a frequency converting, e.g., frequency-tripled, laser may be made using a laser of the type shown in FIG. 3 with the frequency conversion occurring outside the laser cavity. Examples of such lasers are depicted in FIG. 5A and FIG. 5B.

FIG. 5A depicts an externally frequency-tripled laser 500A having as a gain medium a <100>-oriented crystal 502A and pulsing mechanism 514 disposed within a cavity 501A defined by reflecting surfaces 504A, 506B. The gain medium may include dopant ions 507 as described above. The cavity 501, crystal 502, reflecting surfaces 504A, 506B, ions 507, and pulsing mechanism 514 may be as described above with respect to the corresponding components in laser 300 of FIG. 3A. The laser 500A may further include a source 510A of pump radiation 512, which may be a diode laser or flashlamp as described above.

One of the reflecting surfaces, e.g. surface 506B, is partially (e.g., about 10% to about 99%) reflecting with respect to and serves as an output coupler. The laser 500A further includes first and second non-linear elements 516 518 disposed outside the cavity. The first and second non-linear elements are phase-matched as described above to produce third-harmonic radiation TH from the stimulated radiation from the crystal 502A that emerges from the output coupler 506A. Because of the external configuration of the non-linear crystals 516, 518, they need not have Brewster-cut faces. The ultra-low loss of a Brewster face is not as important, though still of some value, with respect to wavelength separation. A higher intensity in e.g., LBO is required for higher conversion efficiency (e.g., greater than about 20%). Thus, focusing into LBO or short pulses with high powers may be needed.

FIG. 5B depicts another frequency tripled laser 500B, which is a variation on the laser of FIG. 5A. Like laser 500A, laser 500B has a crystal gain medium 502B and pulsing mechanism 514 disposed within a cavity 501B defined by reflecting surfaces 504B, 506B. The crystal 502B may include dopant ions 507 as described above. The laser 500B further includes a source 510B of pump radiation 512, which may be a diode laser as described above. The laser 500B also includes first and second non-linear elements configured for frequency tripling of stimulated emission from the gain medium 502B that emerges from the cavity 501. Like laser 500A, one of the reflecting surfaces (506B) serves as an output coupler. Unlike the laser 500A, the other reflecting surface 504B also serves as an input coupler for the pumping radiation 512. When used as an input coupler, the reflecting surface 504B transmits the pump radiation 512 and reflects stimulated emission from the gain medium 502B. The reflecting surface/input coupler 504B may also coincide with one of the end faces of the crystal 502B.

Embodiments of the present invention may also be extended to the use of <100>-oriented crystal gain media used in optical equipment other than lasers. For example, gain media used in optical amplifiers can benefit from the reduced depolarization and thermal lens effects associated with substantially <100>-oriented crystal gain media as described above. An optical amplifier is similar to a laser in that it uses a gain medium driven by pumping radiation. The amplifier generally lacks feedback (i.e. an optically resonant cavity), so that it has gain but does not oscillate. By way of example, an optical amplifier could include a <100>-oriented crystal gain medium and pump source, e.g., configured as described above with respect to the crystal 302 and source 310 FIG. 3A.

Embodiments of the present invention allow for lower depolarization without having to completely re-engineer an existing design. Thus, a whole new class of low-depolarization lasers can be made commercially available without compromising other performance parameters.

While the above includes a complete description of particular embodiments of the present invention, it is possible to use various alternatives, modifications and equivalents. Therefore, the scope of the present invention should be determined not with reference to the above description but should, instead, be determined with reference to the appended claims, along with their full scope of equivalents. The appended claims are not to be interpreted as including means-plus-function limitations, unless such a limitation is explicitly recited in a given claim using the phrase “means for.”

1. A laser, comprising:
an optically resonant cavity defined by two or more reflecting surfaces;
a substantially <100>-oriented crystal disposed within the cavity, wherein the crystal is characterized by a crystal orientation such that a <100> plane of the crystal is oriented substantially perpendicular with respect to a direction of propagation of a beam of stimulated radiation within the crystal; and
a pump source configured to provide pumping energy to a pumped region of the crystal,
wherein an absorbed pump power of the pumping energy is less than about 1000 watts and/or a cross-sectional overlap between a beam of radiation propagating through the crystal and the pumped region is greater than about 20% of a cross-sectional area of the pumped region,
wherein the use of the substantially <100>-oriented crystal reduces depolarization loss or thermal lensing compared to a substantially similarly configured gain medium made from the same material as the substantially <100>-oriented crystal but having instead a substantially non-<100>-orientation.

2. The laser of claim 1 wherein a diameter of a beam of radiation propagating through the crystal is greater than about 45% of a diameter of the crystal.

3. The laser of claim 1 wherein the crystal is not naturally birefringent.

4. The laser of claim 1 wherein the crystal has a simple cubic structure.

5. The laser of claim 1 wherein the crystal is selected from the group of yttrium aluminum garnet (YAG) and gadolinium scandium gallium garnet (GSGG).

6. The laser of claim 1, wherein the crystal is yttrium aluminum garnet (YAG).

7. The laser of claim 1 wherein the crystal is Tm:Ho:YAG, Yb:YAG, Nd:YAG or Er:YAG.

8. The laser of claim 1 wherein the crystal is Nd:YAG.

9. The laser of claim 1 wherein the pump source is configured to provide the pumping energy through a side of the crystal that is oriented substantially parallel to the direction of propagation.

10. The laser of claim 9 wherein the crystal is disposed within a pump cavity configured to reflect the pumping energy back into the crystal.

11. The laser of claim 10, further comprising one or more beam-shaping elements configured to provide the beam of stimulated radiation with a substantially elliptical cross-section within the crystal.

12. The laser of claim 1 further comprising first and second non-linear elements configured such that the laser is a frequency tripled laser.

13. The laser of claim 12, wherein the first and second non-linear elements are disposed within the cavity, whereby the laser is an intracavity frequency-tripled laser.

14. The laser of claim 1, wherein the crystal gain medium is oriented such that the polarization of the stimulated radiation is directed substantially along a diagonal between two crystal axes other than the <100> axis.

15. A method for reducing depolarization loss or thermal lensing, in a gain medium in a laser or optical amplifier, the method comprising:
using as the gain medium, a crystal characterized by a crystalline orientation such that a <100> plane of the crystal is oriented substantially perpendicular with respect to a direction of beam propagation within the crystal; and
providing pumping energy to a pumping region of the crystal,
wherein an absorbed pump power of the pumping energy is less than about 1000 watts and/or a cross-sectional overlap between a beam of radiation propagating through the crystal and the pumped region is greater than about 20% of a cross-sectional area of the pumped region,
wherein the use of the substantially <100>-oriented crystal reduces depolarization loss or thermal lensing compared to a substantially similarly configured gain medium made from the same material as the substantially <100>-oriented crystal but having instead a substantially non-<100>-orientation.

16. The method of claim 15 wherein a diameter of a beam propagating through the crystal is greater than about 45% of a diameter of the crystal.

17. The method of claim 15 wherein the crystal is a fluoride crystal or an oxide crystal.

18. The method of claim 15 wherein the crystal is not naturally birefringent.

19. The method of claim 15 wherein the crystal is selected from the group of yttrium aluminum garnet (YAG) and gadolinium scandium gallium garnet (GSGG).

20. The method of claim 15, wherein the crystal is yttrium aluminum garnet (YAG).

21. The method of claim 15 wherein the crystal is Tm:Ho:YAG, Yb:YAG, Nd:YAG or Er:YAG.

22. The method of claim 15 wherein the crystal has a simple cubic structure.

23. The method of claim 15 wherein the crystal is disposed within an optical cavity of a laser.

24. The method of claim 15 wherein providing energy to the pumping region of the crystal includes side-pumping the crystal.

25. The method of claim 15 wherein the crystal gain medium is oriented such that the polarization of the stimulated radiation is directed substantially along a diagonal between two crystal axes other than the <100> axis.

26. The use in a laser or optical amplifier as a gain medium of a crystal characterized by an orientation such that a <100> plane of the crystal is oriented substantially perpendicular with respect to a direction of beam propagation within the crystal, wherein the crystal absorbs a power less than or equal to about 1000 watts of pumping energy and/or a cross-sectional overlap between a beam of radiation propagating through the crystal and a pumped region of the crystal, is greater than about 20% of a cross-sectional area of the pumped region of the crystal,
wherein the use of the substantially <100>-oriented crystal reduces depolarization loss or thermal lensing compared to a substantially similarly configured gain medium made from the same material as the substantially <100>-oriented crystal but having instead a substantially non-<100>-orientation.

27. The use of claim 26 wherein a diameter of a beam propagating through the crystal is greater than about 45% of a diameter of the pumped region of the crystal.

28. The use of claim 26 wherein the crystal is not naturally birefringent.

29. The use of claim 26 wherein the crystal has a simple cubic structure.

30. The use of claim 26 wherein the crystal is selected from the group of yttrium aluminum garnet (YAG) and gadolinium scandium gallium garnet (GSGG).

31. The use of claim 26, wherein the crystal is yttrium aluminum garnet (YAG).

32. The use of claim 26 wherein the crystal is Tm:Ho:YAG, Yb:YAG, Nd:YAG or Er:YAG.

33. The use of claim 26 wherein the crystal is Nd:YAG.

34. The use of claim 26 wherein the pumping energy is provided to the pumped region by side-pumping the crystal.

35. The use of claim 26 wherein the crystal gain medium is oriented such that the polarization of the stimulated radiation is directed substantially along a diagonal between two crystal axes other than the <100> axis.

36. An optical amplifier, comprising a gain medium in the form of a crystal characterized by an orientation such that a <100> plane of the crystal is oriented substantially perpendicular with respect to a direction of beam propagation within the crystal, wherein the crystal absorbs a power less than or equal to about 1000 watts of pumping radiation and/or a cross-sectional overlap between a beam of radiation propagating through the crystal and a pumped region of the crystal, is greater than about 20% of a cross-sectional area of the pumped region of the crystal,
wherein the use of the substantially <100>-oriented crystal reduces depolarization loss or thermal lensing compared to a substantially similarly configured gain medium made from the same material as the substantially <100>-oriented crystal but having instead a substantially non-<100>-orientation.
